(19) United States
(12) Patent Application Publication
(10) Pub. No.: US 2012/0261076 A1
(43) Pub. Date: Oct. 18, 2012

(54) DEVICE FOR SEPARATION OF A STACKED STRUCTURE AND ASSOCIATED METHOD

(76) Inventors: Hubert Moriceau, St Egreve (FR); Sylvie Sartori, Meylan (FR); Philippe Montmayeul, Berninb (FR); Chridtophe Morales, Pont De Claix (FR)

(21) Appl. No.: 12/444,062

(22) PCT Filed: Oct. 4, 2007
(86) PCT No.: PCT/EP2007/060548

§ 371 Date: Nov. 3, 2009

(30) Foreign Application Priority Data
Oct. 6, 2006 (FR) 06 54138

(51) Int. Cl. B32B 43/00; B26D 1/12

(52) U.S. Cl. 156/701; 156/763

(57) ABSTRACT

A device for separation of a stack in two distinct parts, including a first part, a second part and a zone of weakness between the first and second parts, and an insertion zone located at the periphery of the stack at or close to the zone of weakness, extending over all or part of the periphery of the stack. The device includes at least one separator capable of penetrating into the insertion zone along a penetration distance until coming into contact with the first part of the stack at at least one first contact point located at the periphery of the stack, and coming into contact with the second part of the stack at at least one second contact point located at the periphery of the stack. The device also includes drive means for making the separator penetrate into the insertion zone as far as the penetration distance and for applying a relative movement between the separator and the stack. The separator is configured such that the distance between the first contact point and the second contact point increases during the relative movement, the first and second contact points remaining at the periphery of the stack during the relative movement.

### PRIORITY CLAIM

This application is a U.S. nationalization of PCT Application No. PCT/EP2007/060548, filed Oct. 4, 2007, and claims priority to French Patent Application No. 0654138, filed Oct. 6, 2006, the entire contents of which are hereby incorporated herein by reference.

### TECHNICAL FIELD

The invention relates to a device for partially or completely separating a stacked structure, and a method using this device.

### BACKGROUND

In the microelectronics field, it is important to have precise knowledge about the bonding energy of stacked structures, particularly to be able to guarantee the integrity of these structures during subsequent processes.

One method of measuring the bonding energy was described in 1988 by W. P. Maszara et al., Journal of Appl. Phys., No. 64(10), 15 Nov. 1988, p 4943. This method consists of inserting a razor blade between two wafers in a bonded structure, the blade being inserted by translation at the bonding interface towards the centre of the structure, parallel to the bonding interface plane. At the time, this technique of inserting a blade into a structure was only used to measure the bonding energy and only caused partial opening of the bonded structure over a certain length L.

A few years later, some authors suggested that this blade insertion technique could be used to completely separate bonded structures. To induce this separation, the blade is inserted along a radial axis of the bonded structure and in (or at least close to) the plane of the bonding interface. This complete separation of the bonded structure is obtained using the same basic technique as is used in the Maszara article, taking care to generate a separation from one edge of the bonded structure as far as the centre of the bonded structure, or even to the diametrically opposite edge of the structure.

According to one variant, several blades can be radially inserted into the bonding interface plane of bonded structures simultaneously (see J. Bagdahn and M. Petzold, Debonding of Wafer-Bonded Interfaces for Handling and Transfer Applications, Wafer Bonding Applications and Technology, ed. Springer). By using several blades, separations of bonded structures can be initiated from several peripheral zones, these separations then combining in the central zone to obtain total separation of the bonded structure.

These different techniques can be used to separate structures at a bonding interface, but also along a separation plane corresponding to a plane of weakness or a plane of excessive stresses existing in the stacked structure.

Automatic equipment exists to induce separation by the use of circular concave shaped blades with a diameter corresponding to the diameter of the structure to be separated, to relatively automatically induce separations of the stacked structure at a bonding interface plane, a plane of weakness or a plane of excessive stresses. Movement of these blades is a translation from the periphery towards the centre of the structure to be separated (for example see European Patent No. 1 385 683 B1). Here again, the blade is inserted into the structure by translation from the periphery towards the centre of the structure to be separated.

The disadvantage of these various techniques is that by inserting the blade(s) between the faces of a bonded structure and then moving them radially between these faces, impurities are also introduced on these faces over the entire displacement zone (possibly as far as the centre of the structure) and/or these faces are deteriorated (appearance of scratches, defects, and the like).

### SUMMARY

The purpose of the invention is to disclose a device and a method for separating a stack with a zone of weakness, for example a bonded structure composed of two layers around a bonding interface or a structure with a zone of weakness, for example obtained by implantation of gaseous species (for example hydrogen), which allow to separate this stack into two distinct layers on each side of the zone of weakness while reducing the introduction of impurities and the appearance of scratches on the faces of said separated layers.

Note that the term “separation” in this description must be interpreted as being a dissociation or even a detachment.

This and other purposes are achieved according the invention by a device for separation of a stack in two distinct parts, said stack comprising a first part, a second part and a zone of weakness intermediate between said first and second parts, and an insertion zone located at the periphery of the stack at or close to the zone of weakness, extending over all or part of the periphery of the stack, said device comprising:

at least one separator capable of penetrating into the insertion zone along a distance called the penetration distance, until coming into contact with the first part of the stack at at least one first contact point located at the periphery of the stack and coming into contact with the second part of the stack at at least one second contact point located at the periphery of the stack;

drive means capable of making the separator penetrate into the insertion zone as far as said penetration distance and capable of applying a relative movement between said separator and the stack;

said device being characterised in that the separator is configured such that the distance between the first contact point and the second contact point increases during the relative movement, while the penetration distance remains approximately constant, the first and second contact points remaining at the periphery of the stack during the relative movement.

Advantageously, the relative movement is an essentially tangential movement.

The separator and the stack are driven by a relative movement such that the stack can for example move along the perimeter of the separator at the zone of weakness. The separator perimeter is the same as the circumference of the separator if the separator is circular in shape.

The separator is configured such that the distance between the first contact point and the second contact point increases as the separator moves along the perimeter of the stack so as to separate the two parts from each other.

The separation device according to the invention can induce a separation of a stacked structure, starting from the peripheral zone of the stacked structure. Advantageously, separation is achieved by a progressive increase in the separation of the contact points, these contact points remaining within the peripheral zone of the stack, due to the relative movement between the structure and the separator. Thus, the relative movement between the structure and the separator is essentially tangential.

The peripheral zone means a zone at the edge of the stacked structure, for example the chamfer zone at the edge of the wafers, the zone from which wafers were cut-out, the zone in which there will be no subsequent process operations. In the microelectronics field, the peripheral zone is usually called the exclusion zone, in contrast to the active zone in which integrated circuits are made.

The insertion zone is adapted to insertion of the separator (for example a notch), in other words it enables insertion of the separator. It may for example be composed of the two chamfers of bonded wafers to be separated at this bonding interface or a zone of weakness located close to this bonding interface.

According to a first variant, the relative movement between the separator and the stack is obtained by rotating the separator about itself.

According to a second variant, possibly combined with the first variant, the relative movement between the separator and the stack is obtained by rotating the stack about the separator.

Advantageously, the relative movement between the separator and the stack is also obtained by rotating the stack about itself.

Advantageously, the relative movement between the separator and the stack is also obtained by rotating the separator about the stack.

According to a third variant, the relative movement between the separator and the stack is also obtained by translation of the separator tangentially to the stack.

According to a fourth variant, possibly combined with the third variant, the relative movement between the separator and the stack is obtained by translation of the stack along the separator.

Advantageously, the relative movement between the separator and the stack is also obtained by rotating the stack about itself.

Advantageously, the relative movement between the separator and the stack is also obtained by rotating the separator about the stack.

According to one particular embodiment, the separator comprises a part with an inclined edge with an angle that increases along at least a portion of its periphery, this part of the inclined edge being designed to come into contact with the substrate during the relative movement.

According to another particular embodiment, the separator comprises a cone that may or may not be truncated, the generatrix of said cone being capable of coming into contact with the stack at the first contact point and the base of said cone being capable of coming into contact with the stack at the second contact point. Thus, the generatrix of the cone comes into contact with the first part of the stack and the base of said cone comes into contact with the second part of the stack.

According to another particular embodiment, the separator comprises two cones that may or may not be truncated, superposed at their corresponding bases, the generatrix of the first cone being capable of coming into contact with the stack at the first contact point and the generatrix of the second cone being capable of coming into contact with the stack at the second contact point. Thus, the generatrix of the first cone comes into contact with the first part of the stack and the generatrix of the second cone comes into contact with the second part of the stack.

Advantageously, the axes of the two cones are offset from each other.

Advantageously, the axes of the two cones are inclined relative to each other.

For example, this method can be used to make a separator by the intersection of two cones with coincident or offset axes, or axes inclined relative to each other.

According to another particular embodiment, the separator comprises a prism, the base of which can come in contact with the stack at the first contact point and one of the faces can come into contact with the stack at the second contact point, the base and said face forming an acute angle that may or may not be truncated. Thus, the base of the prism comes into contact with the first part of the stack and the face of the prism forming an acute angle with the base comes into contact with the second part of the stack.

According to another particular embodiment, the separator comprises two prisms, each prism having a base and a face, the base and said face forming an acute angle that may or may not be truncated, and the prisms being superposed at their corresponding bases, the faces of the two prisms being designed to come into contact with the first and second parts of the stack respectively.

Advantageously, the zone of weakness is a bonding interface, a plane of weakness or a plane of excessive stresses.

Advantageously, the insertion zone is a hollow zone.

Advantageously, the first and second parts are layers.

Advantageously, the separation obtained using the device is complete or partial.

The invention also relates to a method for separating a stack in two distinct parts, the stack comprising a first part, a second part and a zone of weakness inserted between said first and second parts, and an insertion zone, located at the periphery of the stack at or close to the zone of weakness, extending over all or part of the periphery of the stack. This method comprises the following steps:

a) supply of at least one separator comprising an inclined edge part, the angle of which increases along at least part of its periphery;

b) insert the inclined edge part of said at least one separator into the insertion zone at a distance called the penetration distance, to bring the separator into contact with at least the first part of the stack at a first contact point and the second part of the stack at a second contact point;

c) apply a relative movement between the separator and the stack such that the inclined edge part of the separator with an increasing angle remains in contact with the substrate during the relative movement to increase the existing distance between the first and second contact points of the separator with the first and the second part of the stack respectively during the relative movement, such that said parts separate from each other while the penetration distance remains approximately constant, the first and second contact points remaining at the periphery of the stack during the relative movement.

Advantageously, the relative movement is an essentially tangential movement.

According to a first variant, the relative movement between the separator and the stack is obtained by rotating the separator about itself.

According to a second variant, possibly combined with the first variant, the relative movement between the separator and the stack is also obtained by rotating the stack about the separator.

Advantageously, the relative movement between the separator and the stack is also obtained by rotating the stack about itself.

Advantageously, the relative movement between the separator and the stack is also obtained by rotating the separator about the stack.

According to a third variant, the relative movement between the separator and the stack is also obtained by translating the separator tangentially to the stack.

Advantageously, the relative movement between the separator and the stack is also obtained by translating the stack along the separator.

Advantageously, the relative movement between the separator and the stack is also obtained by rotating the stack about itself.

Advantageously, the relative movement between the separator and the stack is also obtained by rotating the separator about the stack.

According to a first embodiment, the separator is configured such that the distance between the first contact point and the second contact point increases during the relative movement between the stack and the separator.

Advantageously, the separator is a separator of the separation device described above.

Advantageously, the increase in said distance between the first contact point and the second contact point is obtained by a system that dynamically adapts said distance on the separator. For example, if the separator comes into contact with the stack at two of its walls, the system can separate these walls from each other during time, advantageously progressively as a function of time.

According to a second embodiment, steps a) and b) in the method are repeated N times (N≧2), each time using a different separator with a distance between the first and second contact points of the separator with the first and second parts of the stack greater than the maximum distance of the separator previously used. The separation is thus achieved by successive insertion of separators with an increasing maximum distance between two contact points of the separator and the stack. A special case of this second embodiment consists of using separators for which the maximum distance is constant (in other words it does not change during the relative movement between the separator and the stack, once contact has been obtained). Thus for example, if conical separators are used for which the base and the generatrix come into contact with the first part and the second part of the stack respectively, separators will be chosen for which the angle between the base and the generatrix is increasingly large.

Advantageously, the distance between the first and second contact point of the separator with the first and the second part of the stack is constant for each separator.

### BRIEF DESCRIPTION OF THE DRAWINGS

The invention will be better understood and other advantages and special features will become clear after reading the following description given as a non-limitative example, together with the appended drawings in which:

FIGS. 1 to 4 show examples of a separator in the shape of a prism in accordance with an embodiment of the invention,

FIG. 5 shows an example of a separator composed of two cones attached at their bases in accordance with an embodiment of the invention;

FIG. 6 shows a diagrammatic view of a cone with different generatrix angles in accordance with an embodiment of the invention;

FIGS. 7 to 16 show top views of a device according to the an embodiment of the invention comprising a separator and a stack (circular in shape), and in particular:

FIGS. 7 to 10 show example embodiments in which the separator or the stack moves with a translation movement relative to the stack or the separator, respectively;

FIGS. 11 and 12 show example embodiments in which the separator, and possibly the stack, rotate about themselves;

FIGS. 13 to 16 show example embodiments in which the separator or the stack rotates about the stack or the separator, respectively;

FIG. 17 shows a front view of a separator in contact with a stack according to the invention;

FIG. 18 shows an enlarged detail of FIG. 17;

FIG. 19 shows a front view of a stack to be separated.

### DETAILED DESCRIPTION OF PARTICULAR EMBODIMENTS

The separation device can be used to dissociate the layers in a stacked structure. The stack can be separated in two distinct parts at a bonding interface between two layers, at a plane corresponding to a plane of weakness, or at a zone of excessive stresses in the stacked structure.

For bonded structures, the bonding interface corresponds to a plane of weak links between two bonded layers, for example, by molecular bonding.

In the case of structures containing weak plane zones or stressed zones, they will be planes that are different from or weaker than the bonding interfaces, for example such as zones obtained by the implantation of gaseous species in a substrate, an interface of a deposited layer, a zone with a different nature or morphology (for example a buried oxide or porous silicon zone) or zones in which applied stresses are high.

The device according to the invention comprises at least one separator. The separator may be any body capable of inducing a progressive increase in the spacing between the contact points of this separator with the stack to be dissociated, this contact being limited to the peripheral zone of the stack. Preferably, since in general the separator must be inserted between wafers at or close to a thin weak zone, the separator will be formed of two walls that come together to form a projecting part (acute angle) with an edge. The edge of the separator may for example be circular or straight in shape. As a variant, this edge could be truncated. “Truncated” means that it is truncated by a plane or curved surface.

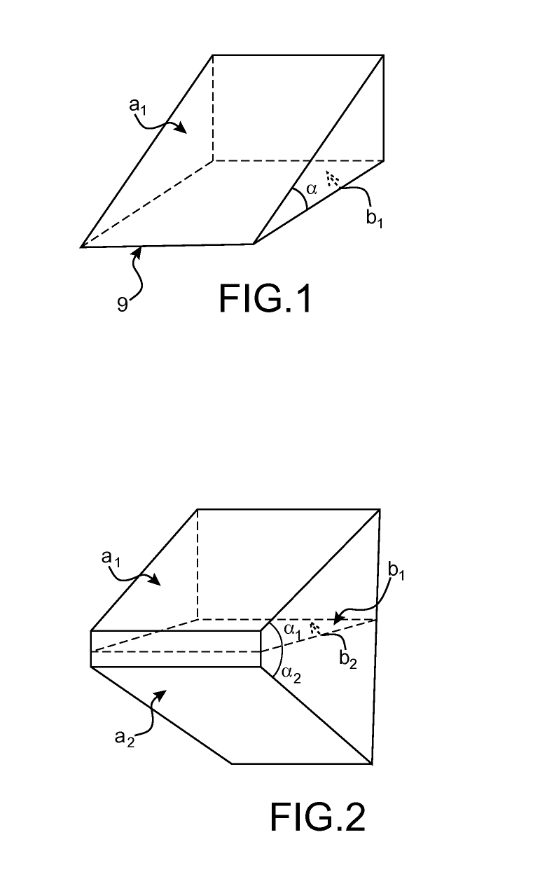

A separator with a straight edge can be made using any body with a straight skew edge, for example a prism. For example, the separator may be a prism for which the base b1 and the face a1 facing the base are oriented so as to form an acute angle a and come together forming a straight edge 9 (FIG. 1). The end of the prism (in other words the part in which the base and the face come together to form an acute angle) may also be truncated. The separator can also be formed by combining two prisms superposed at their corresponding bases b1 and b2. FIG. 2 shows an example of two superposed prisms, with their end truncated and identical angles α₁ and α₂. In this case, the ends have been truncated by a plane, but it would also have been possible to truncate them along a curved surface. The angles α₁ and α₂ could have been different.

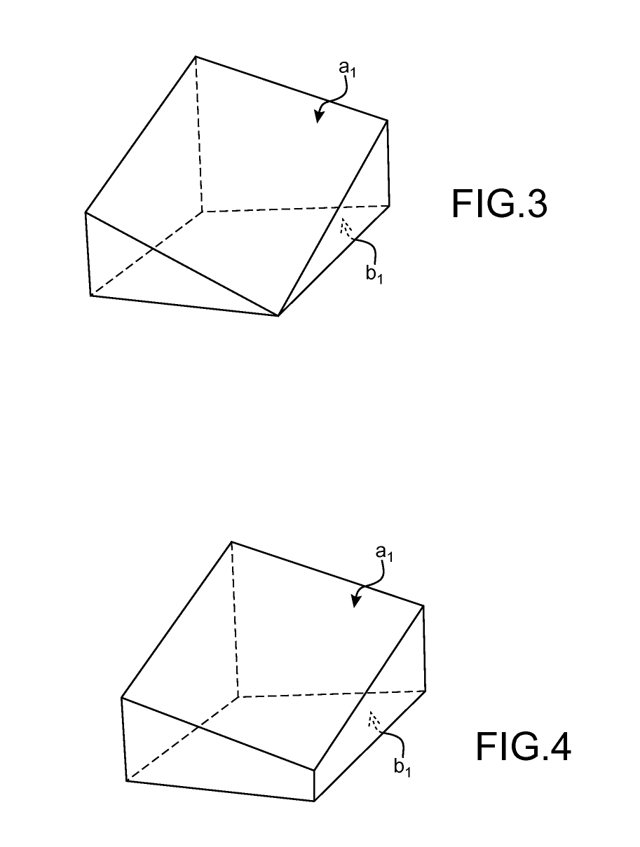

The edge can also be in other shapes. For example, the separator may be a prism in which the base b1 and the face a1 facing the base come together at a vertex to form an acute angle (FIG. 3). The base b1 and the face a1 facing the base may also come close to each other, without actually coming together (FIG. 4).

One way of making a separator with a circular shaped edge would for example be to use a cone, the generatrix of this cone then forming the edge of an acute angle. In this case, a separator with a variable height between the contact points between the separator and the layers in the stack is made by offsetting the axis of rotation of the separator from its axis of symmetry in the case in which the separator will be rotated, and/or the axis of rotation of the structure is offset from its axis of symmetry if the structure to be separated is circular and will be rotated.

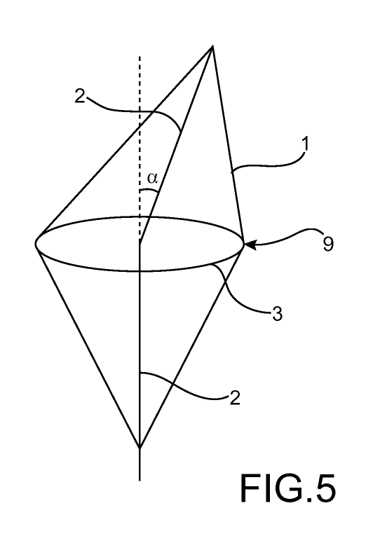

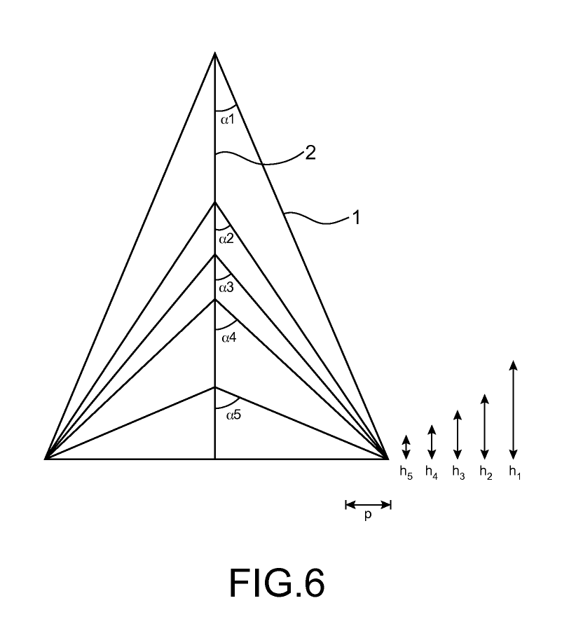

A separator with a circular shaped edge can also be made by joining two cones at their bases. Starting from these cones, different heights can be obtained by modifying the angle of the generatrices 1 of the cones and/or the angle between the axes 2 of these two cones. For example, the separator can be made by inclining the axes 2 of the two cones relative to each other by an angle a equal to about 20° (see FIG. 5). It would also be possible to vary the angle of the generatrix 1 relative to the axis 2 of each of the cones; for example, this angle could be equal to 10°, 20°, 30°, 45° or 60°. Depending on the chosen angle of the generatrix 1 α₂, α₃, α₄, α₅, the separator has different heights h₁, h₂, h₃, h₄, h₅ for a given depth p, as shown in FIG. 6, in which the separator is composed of a single cone.

If the separator is composed of two cones, the angles of the generatrices of the two cones may be chosen to be identical or different.

In order to make the separation, the separator and the stacked structure to be dissociated must be driven by a relative movement essentially tangential to the stacked structure such that the separation between the contact points of the separator and the layers in the stack vary so as to increase during the movement. Advantageously, the increase is progressive. This relative movement can be obtained in a different manner by movement of the separator and/or the structure.

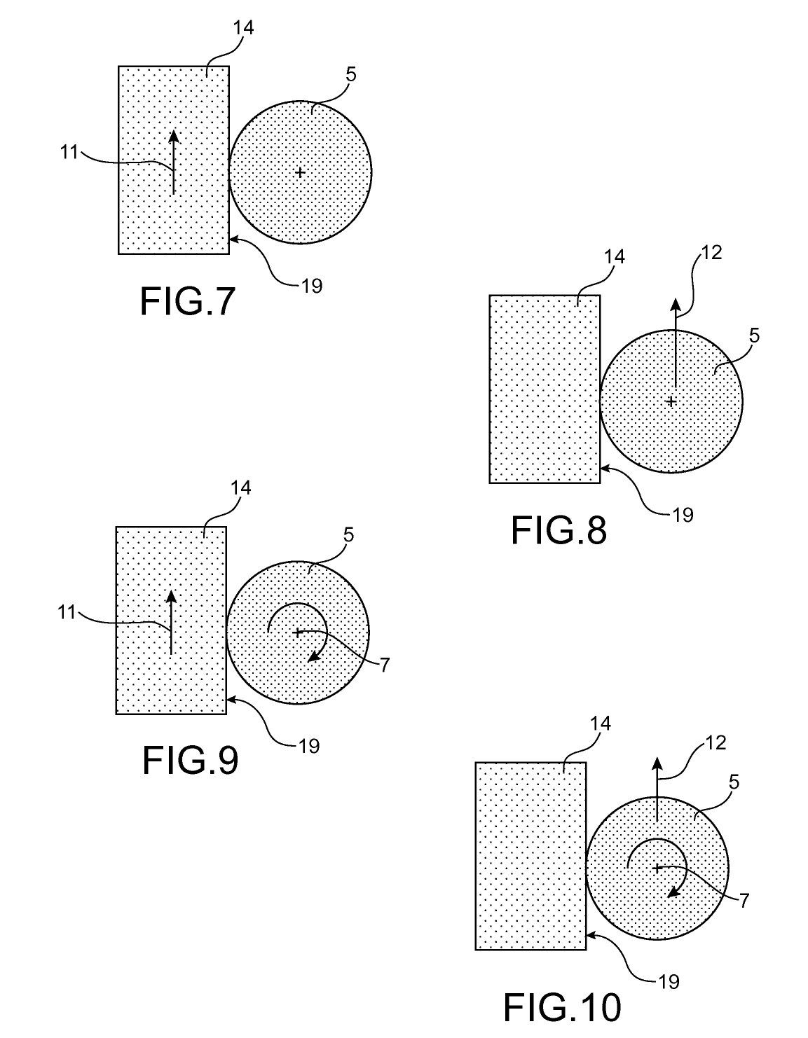

For example, if the separator 14 has a straight edge 19 and if the stacked structure 5 is circular in shape, the separator 14 can be translated along a direction 11 tangential to the stacked structure (FIG. 7) to induce separation of the contact points. The case in which the separator 14 remains fixed is also possible, while the stack 5 makes a translation movement 12 along the edge 19 (FIG. 8) or a combination of these two translation movements. Advantageously, in these variants, it will be possible to rotate the structure 5 about itself (about its rotation axis 7), so as to initiate separation on a part or over the entire periphery of the structure and thus better distribute stresses generated on the structure (see FIG. 9 in which the stack rotates about itself, or FIG. 10 in which the stack has a translation movement and rotates about itself). It would also be possible (as an alternative or in combination) to rotate the separator 14 about the rotation axis 7 of the stack 5 (not shown). The translation and rotation movements may or may not be continuous, partial or complete, simultaneous or not, etc.

If the separator 4 and the stack 5 are circular in shape, separation can be initiated according to the following cases (alone or in combination):

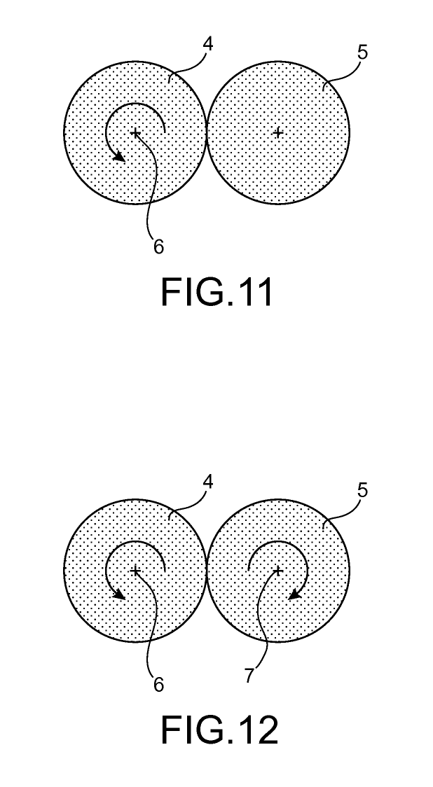

the separator 4 rotates about itself about its rotation axis 6, while the stack 5 remains fixed (FIG. 11),

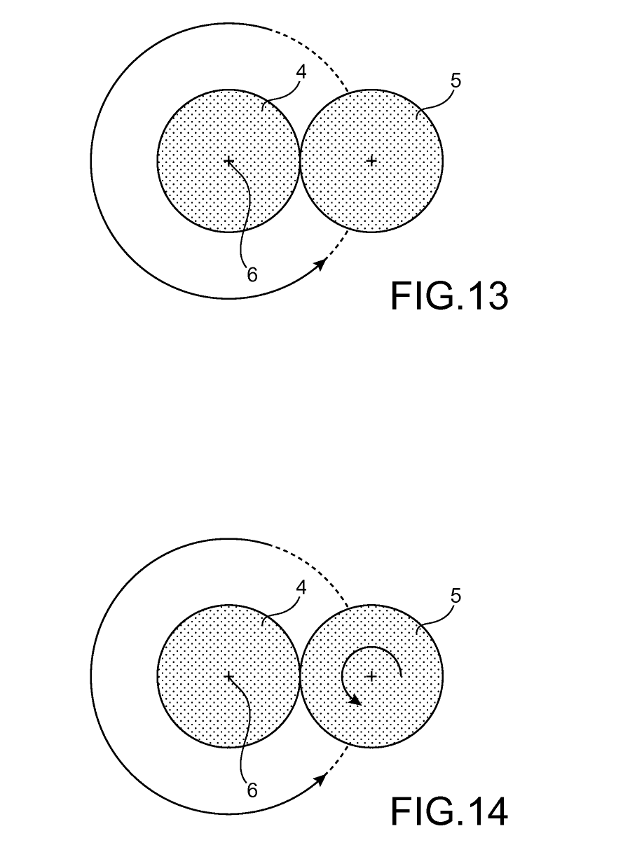

the separator 4 remains fixed, while the stack rotates about the rotation axis 6 of the separator (FIG. 13).

These two basic movements can make the separation. These two basic movements may be combined. These rotation movements may be continuous or in steps, in the same direction or with isolated changes in the rotation direction. These rotations can be combined (simultaneously or not) with rotations in the same or opposite directions.

Thus, separation is initiated locally around the periphery of the structure. This separation can be generated around a larger part of the periphery of the structure or around the entire periphery, so as to better distribute stresses generated on the structure, therefore the following movements are possible in addition to the rotation movements described above (wholly or partly simultaneous with these rotation movements):

a rotation movement of the structure about itself (continuous or in steps, alternate or not)

and/or

a rotation movement of the separator about the axis of the structure (simultaneous or not).

The following cases can thus occur:

the separator 4 and the stack 5 rotate about themselves about their corresponding axes of rotation 6 and 7 (FIG. 12);

the separator 4 remains fixed, while the stack rotates about itself about its rotation axis 7, and about the rotation axis 6 of the separator (FIG. 14);

the separator 4 rotates about itself about its rotation axis 6, while the stack rotates about itself about its rotation axis 7, and about the rotation axis 6 of the separator (FIG. 15);

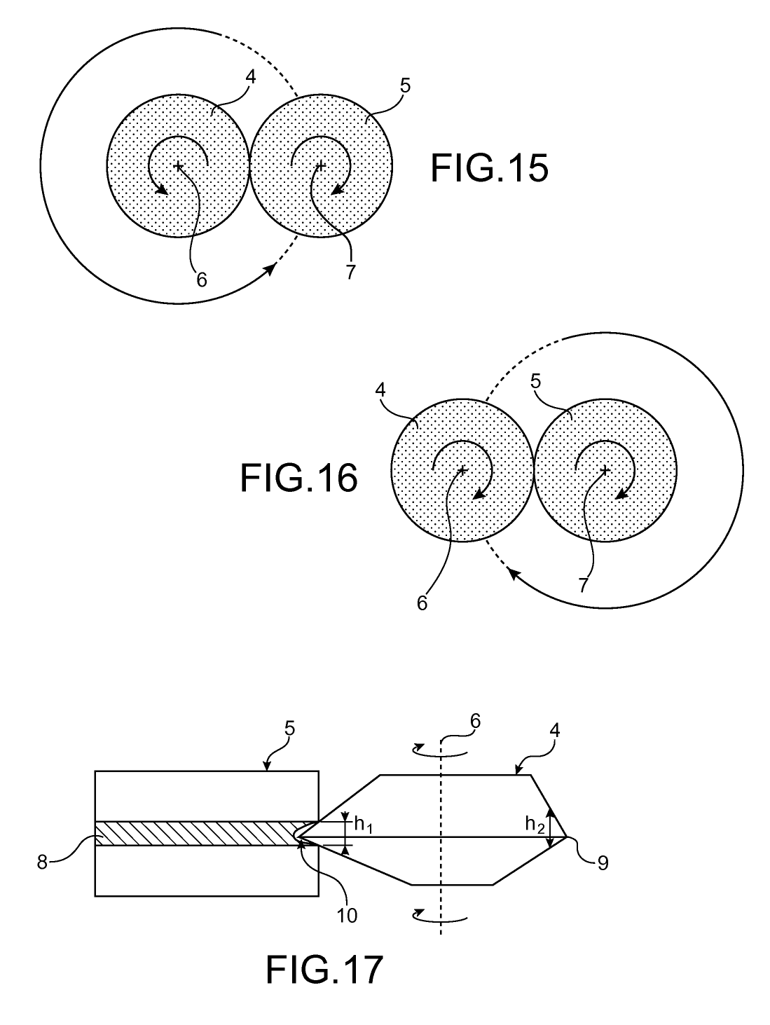

the separator 4 rotates about the rotation axis 7 of the stack 5 and rotates about itself about its rotation axis 6, while the stack rotates about itself about its rotation axis 7 (FIG. 16).

According to a first example embodiment, the stacked structure to be separated may be composed of two 100 mm diameter 525 micrometer thick silicon wafers. In this example, the two silicon wafers are bonded by molecular bonding, a technique well known to those skilled in the art; the two surfaces are prepared to be hydrophilic and clean, and the two wafers are then bonded at ambient temperature. The result is thus bonding energy of the order of 0.8 J/m² after heat treatment at 500° C. for two hours.

Wafers are provided with a chamfer 10 (in other words a thinned zone) around the periphery. After bonding, these chamfers generate a non-bonded zone 10 around the periphery of the structure at the bonding interface, which will facilitate subsequent insertion of the separator between the two wafers.

In this example, the separator is made by combining two cones at their corresponding bases, the two cones having their axes inclined relative to each other by an angle of about 20°. The vertices of the cones have been truncated.

Since the axes of the two cones are inclined, a variable separation height is obtained. The advantage of having a variable separation height is that a progressive and tangential separation effect is obtained for the two wafers. For example, when the separator has rotated a quarter of a turn, the separation height of the wafers of the stacked structure in the peripheral zone of the stack varies from a few micrometres up to about 3 mm.

In this example, it is decided to rotate the separator 4 about itself about its rotation axis 6. Preferably, the separator is rotated slowly. For example, rotation speeds of 0,1, 1, 2, or 5 turns per hour are used.

The separator (and possibly the stack) can be driven in rotation electrically, automatically and progressively, in steps or in continuous mode.

According to one variant, possibly combined, the stacked structure to be separated may be rotated about the axis of the separator. For example, the separator could be rotated in steps of a tenth ( 1/10^{th}) of a turn, and between each step the structure can be rotated about itself by about at least one complete rotation.

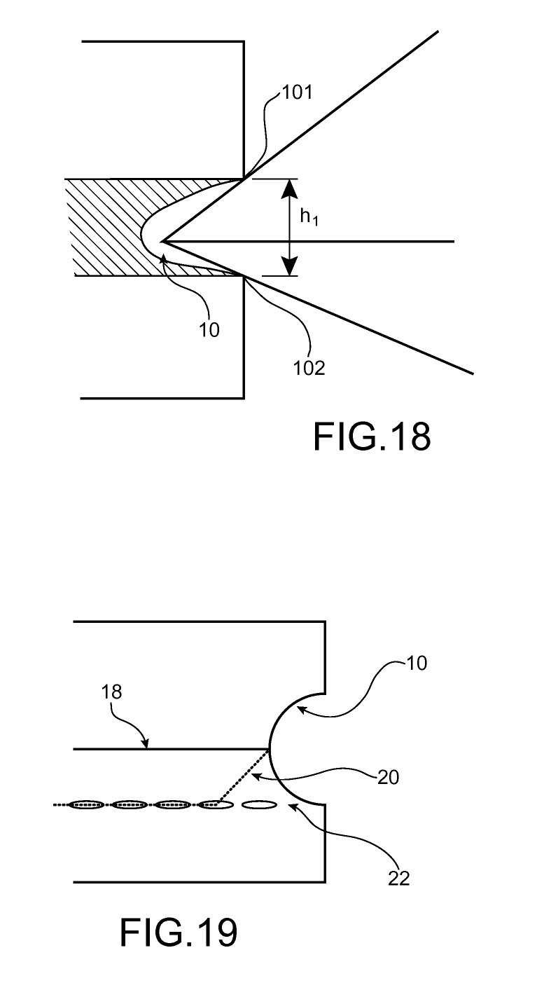

The separator 4 is brought into contact (101, 102) with the edges of each of two wafers of the structure 5 to be separated at the non-bonded zone (forming a zone 10 adapted to insertion of the blade). This non-bonded zone is close to the bonding interface 8, in this case corresponding to the zone of weakness at which it is required to obtain a separation (FIGS. 17 and 18). As can be seen in FIG. 17, the separation height h₁ is smaller than the diametrically opposite separation height h₂; therefore when the separator has made half a turn, the separation height will have changed and the pressure applied on the walls at the contact points 101 and 102 will also have increased.

Creating contact requires a relative radial movement between the structure and the separator but that is limited to the edge of the structure.

The peripheral zone in which contact (101, 102) occurs between the separator with tangential and progressive effect and each of the wafers in the bonded structure is located at about 49 mm from the centre of the bonded structure for 100 mm diameter structures. The separation height at the periphery of bonded wafers imposed by rotation of the separator is sufficient to induce complete separation of the stacked structure.

In one variant of this example, the structure to be separated is located on a support means, for example a plate, which rotates the structure about its axis, continuously or not, in a single direction or in alternate directions, simultaneously or not relative to the rotation of the separator. The rotation speed may be constant or variable. In this example, the rotation speed of the plate is continuous and simultaneous with the separator. It may be 10 turns per hour, or 5 turns per hour, one turn per hour or 0.1 turns per hour. In this example, the rotation of the plate takes place in the same direction and at the same speed as the rotation of the separator.

It can be seen that there is no need to make a radial translation of the separator according to the invention, in other words from the edge of the structure to be separated towards its centre. Simple rotation of the separator, once the separator is in contact with the stack, is sufficient to separate the two parts that have to be separated in the stacked structure. Nevertheless, it will always be possible to provide a small radial component to the relative movement between the separator and the structure. This component must be limited to limit the risks of adding impurities or scratches at the edge of the structure.

According to a second example embodiment, the stacked structure to be separated can be composed of two 100 mm diameter and 525 micrometre thick silicon wafers. As in the previous example, the two surfaces of the wafers to be bonded have been prepared to be hydrophilic and compatible with subsequent molecular bonding. The two wafers were bonded and heat treated at 200° C. for two hours, for example to obtain a bonding energy of the order of 0.6 J/m².

In this example, the separator was made by joining two truncated coaxial cones at their corresponding bases. The vertices of the cones were truncated such that the separator is not as large. A generatrix angle of 45° was chosen for this example.

In this example, the separator and the stacked structure were rotated about themselves. It was chosen to offset the rotation axis of the separator by about 2 mm from the axis of the cones, which makes it possible to vary the separation heights.

The separator is brought into contact with the edges of each of the two wafers of the structure to be separated, in the zone in which these wafers are chamfered. The separator and the stacked structure are rotated about themselves in the same direction or in opposite directions. Preferably, the separator is rotated slowly, for example with rotation speeds of 5 turns per hour, 2 turns per hour, 1 turn per hour, or 0.1 turns per hour.

Since the rotation axis of the separator is offset from the axis of the cones, the separation height of the separator will progressively change as the separator rotates. Preferably, the separator is moved such that separation height increases. Preferably, the separator is located in the chamfer at the point at which the separator has a minimum separation height.

For example, when the separator has made ⅙ of a turn, the separation height of the wafers in the stacked structure can vary by a few micrometres up to about 1.5 mm, in the peripheral zone of the structure.

Such a separation height imposed at the periphery of the bonded wafers is sufficient to induce complete separation of the stacked structure. The relative movement between the separator and the structure has a radial component, but it remains less than twice the difference between the rotation axis of the separator and the axis of the cones, or even less if the separator makes less than one turn, which is small compared with the dimensions of the structure. Therefore, most of the relative movement remains tangential.

According to a third embodiment, the stacked structure to be separated is composed of two silicon wafers assembled by molecular bonding at a bonding interface 18. Before bonding, one of the two wafers is hydrogen implanted to create a buried zone of weakness composed of microcavities 22, for example at 1 μm from its surface (see FIG. 19). The separation must take place in this buried zone of weakness.

Heat treatment can be done after bonding to reinforce the bonding and to facilitate coalescence of the microcavities.

The separator according to the invention is inserted at the bonding interface in the chamfer zone 10 of the wafers close to the zone of weakness comprising microcavities 22, at the same time or later than this heat treatment. The separation then takes place for example by rotating the separator at a fracture line 20 which, as shown in FIG. 19, is done in the plane containing the microcavities 22 and starts from the chamfer zone 10 (the fracture line 20 is shown by a dashed line).

By avoiding the radial insertion of a blade within a stack, the separation device and the method according to the invention can avoid impurities from being introduced onto the surface of separated wafer surfaces and/or scratching these surfaces, while inducing separation of stacked structures from the periphery of the stack. Therefore, the useable surface area of the wafers thus separated is much greater than what is obtained by separation using prior devices, which require the radial insertion of a blade.

A circular shape separator was used in the previous examples. Other shapes of separators are also possible. For example, the separator can be a body comprising two walls that come together at a straight edge. For example, it could be a blade, such as a cutter blade. Also a fixed shape separator was used, but obviously it could be possible to use a separator with a shape that varies with time, so as to dynamically adapt the distance between the contact points of this separator and the stack. It could be a conical separator, in which the angle between the generatrix and the base can vary dynamically, for example under the effect of pneumatic forces.

A single separator is used in the above examples, but it will be quite possible to use two or more separators in combination. Separators may have identical or different shapes, they may rotate at variable speeds and/or in different rotation directions, or they may not rotate.

Without going outside the scope of the invention that is intended to separate a structure at a zone of weakness using a tool and limiting contact between the tool and the structure around the periphery of this structure, particularly so as to avoid any contamination and/or damage at the faces obtained after separation, it would be possible to insert different separators successively around the periphery of the structure. These separators will advantageously be similar to those described previously, in other words inducing a variation in the distance between the contact points between this separator and the structure, either dynamically or during a relative movement between said separator and the structure. As a variant, it will also be possible to use different fixed shape separators chosen such that the contact points between these separators and the structure are restricted to the periphery of the structure, while the distance between these contact points varies from one separator to another and increases, thus causing separation of the structure. For example, conical separators could be used, in which the angle between the base and the generatrix increases progressively from one separator to another, and as insertions progress.

1-33. (canceled)

34. A device for separation of a stack in two distinct parts, the stack comprising a first part, a second part and a zone of weakness between the first and second parts, and an insertion zone located at a periphery of the stack at or close to the zone of weakness, extending over all or part of the periphery of the stack, the device comprising:
at least one separator capable of penetrating into the insertion zone along a penetration distance until contacting the first part of the stack at least one first contact point located at the periphery of the stack and coming into contact with the second part of the stack at at least one second contact point located at the periphery of the stack; and
drive means for making the separator penetrate into the insertion zone as far as the penetration distance and for applying a relative movement between the separator and the stack,
wherein the separator is configured such that the distance between the first contact point and the second contact point increases during the relative movement while the penetration distance remains approximately constant, the at least one first and second contact points remaining at the periphery of the stack during the relative movement.

35. The separation device according to claim 34, wherein the relative movement comprises a substantially tangential movement.

36. The separation device according to claim 34, wherein applying relative movement between the separator and the stack comprises rotating the separator about itself.

37. The separation device according to claim 34, wherein applying relative movement between the separator and the stack comprises rotating the stack about the separator.

38. The separation device according to claim 36 or 37, wherein applying relative movement between the separator and the stack further comprises rotating the stack about itself.

39. The separation device according to claim 36, wherein applying relative movement between the separator and the stack is further comprises rotating the separator about the stack.

40. The separation device according to claim 37, wherein applying relative movement between the separator and the stack further comprises rotating the separator about the stack.

41. The separation device according to claim 38, wherein applying relative movement between the separator and the stack further comprises rotating the separator about the stack.

42. The separation device according to claim 34, wherein applying relative movement between the separator and the stack comprises translating the separator tangentially to the stack.

43. The separation device according to claim 34, wherein applying relative movement between the separator and the stack comprises translating the stack along the separator.

44. The separation device according to claim 42 or 43, wherein applying relative movement between the separator and the stack further comprises rotating the stack about itself.

45. The separation device according to claim 42, wherein applying relative movement between the separator and the stack further comprises rotating the separator about the stack.

46. The separation device according to claim 43, wherein applying relative movement between the separator and the stack further comprises rotating the separator about the stack.

47. The separation device according to claim 44, wherein applying relative movement between the separator and the stack further comprises rotating the separator about the stack.

48. The separation device according to claim 34, wherein the separator comprises a part with an inclined edge having an angle that increases along at least a portion of a periphery of the part, wherein the inclined edge is configured to come into contact with the stack during the relative movement.

49. The separation device according to claim 34, wherein the separator comprises a cone that may or may not be truncated, wherein a generatrix of the cone is configured to contact the stack at the at least one first contact point and a base of the cone is configured to contact the stack at the at least one second contact point.

50. The separation device according to claim 34, wherein the separator comprises two cones that may or may not be truncated, superposed at their corresponding bases, wherein a generatrix of the first cone is configured to contact the stack at the at least one first contact point and a generatrix of the second cone is configured to contact the stack at the at least one second contact point.

51. The separation device according to claim 50, wherein axes of the two cones are offset from each other.

52. The separation device according to claim 50, wherein axes of the two cones are inclined relative to each other.

53. The separation device according to claim 34, wherein the separator comprises a prism having a base and a face, wherein the base is configured to contact the stack at the at least one first contact point and the face is configured to contact the stack at the at least one second contact point, and wherein the base and the face form an acute angle that may or may not be truncated.

54. The separation device according to claim 34, wherein the separator comprises two prisms, each prism having a base and a face, the base and the face forming an acute angle that may or may not be truncated, wherein the prisms are superposed at their corresponding bases, and wherein the faces of the two prisms are configured to contact the first and second parts of the stack, respectively.

55. A method for separating a stack into two distinct parts, the stack comprising a first part, a second part and a zone of weakness between the first and second parts, and an insertion zone, located at a periphery of the stack at or close to the zone of weakness, extending over all or part of the periphery of the stack, the method comprising the following steps:
a) supplying at least one separator comprising an inclined edge part, an angle of which increases along at least a portion of a periphery of the edge part;
b) inserting the inclined edge part of the at least one separator into the insertion zone at a penetration distance to bring the separator into contact with at least the first part of the stack at a first contact point and the second part of the stack at a second contact point; and
c) applying a relative movement between the separator and the stack such that the inclined edge part remains in contact with the stack during the relative movement to increase a distance between the first and second contact points of the separator with the first and the second part of the stack respectively during the relative movement, such that the parts separate from each other while the penetration distance remains approximately constant, the first and second contact points remaining at the periphery of the stack during the relative movement.

56. The method according to claim 55, wherein applying relative movement comprises a substantially tangential movement.

57. The method according to claim 55, wherein applying relative movement between the separator and the stack comprise rotating the separator about itself.

58. The method according to claim 55, wherein applying relative movement between the separator and the stack is comprises rotating the stack about the separator.

59. The method according to claim 57 or 58, wherein applying relative movement between the separator and the stack further comprises rotating the stack about itself.

60. The method according to claim 57, wherein applying relative movement between the separator and the stack further comprises rotating the separator about the stack.

61. The method according to claim 58, wherein applying relative movement between the separator and the stack further comprises rotating the separator about the stack.

62. The method according to claim 59, wherein applying relative movement between the separator and the stack further comprises rotating the separator about the stack.

63. The method according to claim 55, wherein applying relative movement between the separator and the stack comprises translating the separator tangentially to the stack.

64. The method according to claim 55, wherein applying relative movement between the separator and the stack comprises translating the stack along the separator.

65. The method according to claim 63 or 64, wherein applying relative movement between the separator and the stack further comprises rotating the stack about itself.

66. The method according to claim 63, wherein applying relative movement between the separator and the stack further comprises rotating the separator about the stack.

67. The method according to claim 64, wherein applying relative movement between the separator and the stack further comprises rotating the separator about the stack.

68. The method according to claim 65, wherein applying relative movement between the separator and the stack further comprises rotating the separator about the stack.

69. The method according to claim 55, wherein the separator is configured such that the distance between the first contact point and the second contact point increases during the relative movement between the stack and the separator.

70. The method according to claim 69, wherein increasing the distance between the first contact point and the second contact point comprises applying a system that dynamically adapts the distance on the separator.

71. The method according to claim 69, wherein steps a) and b) are repeated N times (N≧2), each time using a different separator with a distance between the first and the second contact points of the separator with the first and the second parts of the stack greater than a maximum distance of the separator previously used.

72. The method according to claim 71, wherein the distance between the first and the second contact points of the separator with the first and the second parts of the stack is constant for each separator.
